(19) United States
(12) Patent Application Publication
(10) Pub. No.: US 2024/0394720 A1
(43) Pub. Date: Nov. 28, 2024

(54) MACHINE-LEARNED MODEL FOR REDUCTION OF PARKING CONGESTION IN AN ONLINE CONCIERGE SYSTEM

(71) Applicant: Maplebear Inc. (dba Instacart), San Francisco, CA (US)

(72) Inventors: Youdan Xu, Burlingame, CA (US); Michael Chen, San Francisco, CA (US); Marina Tanasyuk, San Francisco, CA (US); Matthew Donghyun Kim, Seattle, WA (US); Ajay Pankaj Sampat, San Francisco, CA (US); Caleb Grisell, Los Angeles, CA (US); Yuan Gao, San Mateo, CA (US)

(21) Appl. No.: 18/202,876

(22) Filed: May 26, 2023

(51) Int. Cl. G06Q 10/08; G08G 1/14; H04W 4/02

(52) U.S. Cl. CPC G06Q 30/015; G08G 1/143; H04W 4/025

(57) ABSTRACT

An online concierge system uses a machine-learned parking quality model to quantify the suitability of a particular parking location (e.g., a parking lot, or a street) for use when performing purchases at a retail location on behalf of customers. The parking quality model's output is determined according to input features related to parking at a candidate parking location, such as a current time, a current degree of demand for shoppers at the retail location, or a current average shopper wait time at the retail location before receiving an order. The online concierge system provides suggested alternate parking locations to a client device of the shopper, where they may be displayed, e.g., as part of an electronic map. Use of the suggested alternate parking locations helps to preserve parking availability in restricted areas such as retailer parking lots and to reduce traffic congestion in the area of the retailer.

### BACKGROUND

Concierge systems, which enable assistants to provide assistance to a customer with the customer's errands or other personal business, are of value to both the assistants and the customers, providing the customers with the ability to accomplish tasks for which they lack the time or ability, and the assistants with flexible employment opportunities.

Some concierge systems facilitate assistants performing shopping on behalf of customers, or otherwise traveling to particular physical locations in order to accomplish a task. For example, some assistants purchase groceries or other items at physical stores on behalf of customers. In such cases, assistants may drive or otherwise travel to busy stores before actually receiving a request from a customer, with the expectation that a request will soon arrive and that they will then be ideally positioned to quickly fulfill the customer's request. However, this can sometimes have the effect of making it more difficult to find parking at the physical locations. It would be preferable to be able to select parking locations or other waiting areas that jointly optimize the competing considerations—that is, that effectively take into account both the goal of assistants to minimize the time for them to fulfill a customer request, and the goal of other patrons and of the public to avoid parking scarcity.

### SUMMARY

In accordance with one or more aspects of the disclosure, an online concierge system uses a machine-learned parking model to quantify the suitability of a particular parking location (e.g., a parking lot, or a street) for use when performing purchases at a retail location on behalf of customers. The parking model's output is determined according to a number of input features related to parking at a candidate parking location in the current context, such as: a description of a candidate parking location; a current time; an identifier of the retail location; a current degree of demand for shoppers at the retail location; a current average shopper wait time at the retail location before receiving an order; a current parking capacity of a candidate parking location; and/or safety parameters associated with the parking location.

In some embodiments, the online concierge system first determines whether a current location of a shopper is disfavored as parking for the retail location, such as by applying a machine-learned parking prohibition model, or by determining whether the location is within a known restricted region for the retail location. If it is, then the online concierge system applies the parking model to identify suggested alternate parking locations; otherwise, the shopper may park at the shopper's current location.

The online concierge system provides suggested alternate parking locations to a client device of the shopper, where they may be displayed, e.g., as part of an electronic map.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates components of the waiting direction module of FIG. 2, according to some embodiments.

FIGS. 4A and 4B are flowcharts illustrating steps for producing the parking model of FIG. 3, and for suggesting parking locations to a shopper, according to some embodiments.

### DETAILED DESCRIPTION

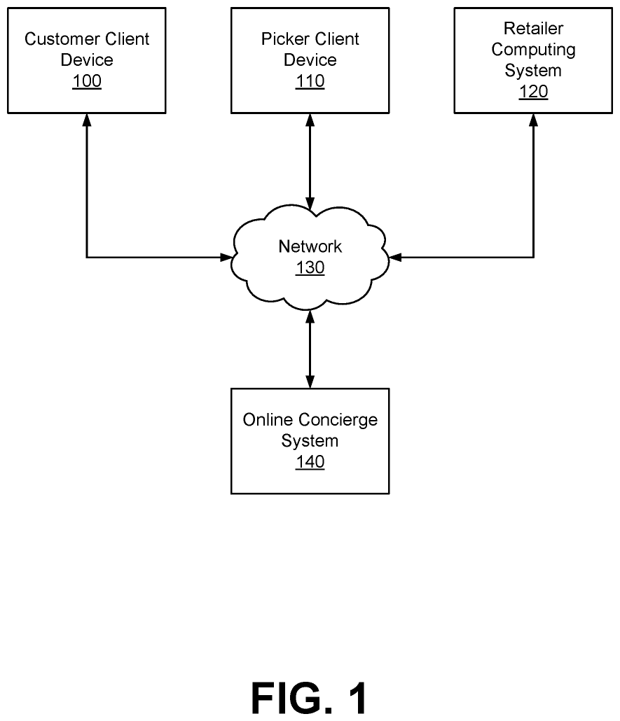

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker (also referred to as a “shopper”) that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, so that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

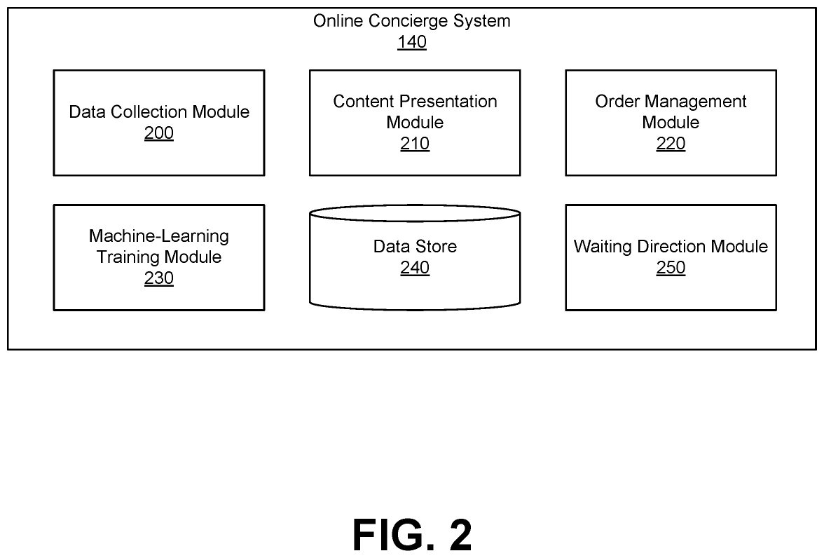

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of the order. In some embodiments, the order management module 220 computes an estimated time of arrival of the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The online concierge system 140 additionally includes a waiting direction module 250 that provides pickers with suggestions of where to park while waiting for an order from a customer. (The term “parking” is used herein to refer generally to pickers proceeding to a waiting location. Such waiting locations are typically parking locations for cars and other vehicles, but more generally can be any location at which there can be competition for waiting space.) As noted, pickers often wish to park near busy retailer locations in order to maximize their probability of being assigned an order, but those retailer locations, and/or the surrounding neighborhood, may wish to avoid monopolization of parking. Thus, the waiting direction module 250 may suggest parking locations that are outside of a certain “restricted region” for a given retailer location, which represents a geographic region in which parking for the retailer location is discouraged, given its tendency to monopolize available parking and/or increase traffic congestion. The restricted region for a given retailer location may be defined in different ways in different embodiments, such as a proximate region within a given distance of a single geographic point corresponding to the retailer location (where distance may be defined in “as the crow flies” manner, as shortest route distance, etc., within some given geometric boundary (e.g., a rectangle or other polygon), or the like. In some embodiments, the distance or geometric boundary is fixed; in other embodiments it can be dynamically determined (e.g., made larger as a function of other variables, such as current or expected degree of congestion).

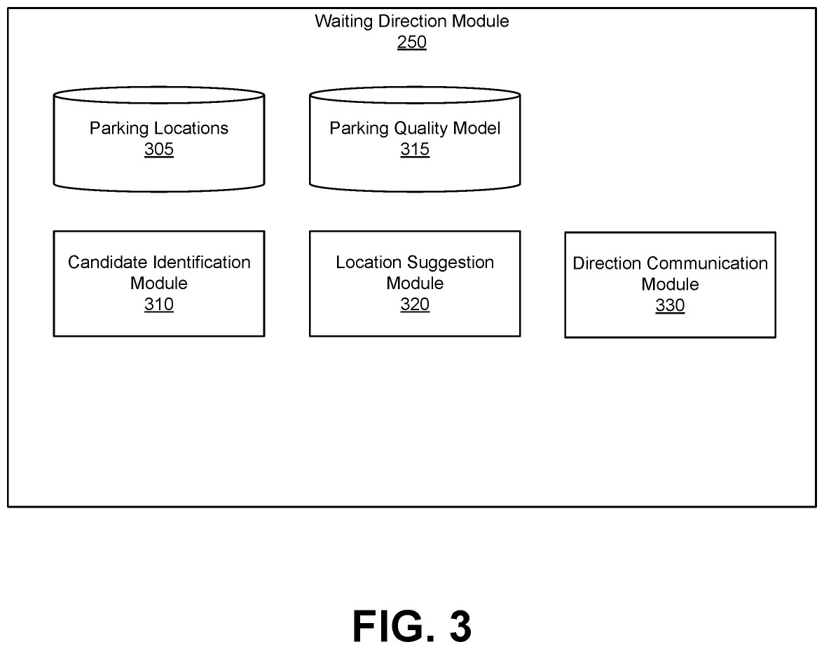

FIG. 3 illustrates components of the waiting direction module 250, according to some embodiments.

The waiting direction module 250 includes a parking locations repository 305 that lists known parking locations. “Parking locations” refer to any locations at which a picker may park (or, more generally, wait), including not only explicit parking lots, but also street parking and the like. The data associated with each known parking location may include a geographic description (e.g., a latitude/longitude coordinate, or a description of an enclosing polygon or other geographic boundaries), a name, an identifier of a store or other pickup location to which the parking location corresponds, and the like.

In some embodiments, the parking locations repository 305 is assembled at least in part by analyzing data about prior orders made through the online concierge system 140. For example, the waiting direction module 250 may analyze logs of prior fulfilled orders, identifying geographic locations of the pickers at the time that the pickers were assigned to the orders. (In order to identify locations that will fall outside of the restricted regions for retailers, orders made when the pickers were at locations within a restricted region may be filtered out of the parking locations repository 305.) In some embodiments, the waiting direction module 250 may also consult existing geographic databases or other mapping systems (e.g., data from Google Maps™) when identifying possible parking locations.

The waiting direction module 250 includes a candidate identification module 310 that identifies candidate parking locations, such as for a given retailer location, or for a given picker location. (If the picker does not explicitly provide a retail location, the candidate identification module 310 may map a given location, such as a GPS coordinate, to a retail location by consulting a geographic database and determining a nearest retail location for the given location.) In some embodiments, the candidate identification module 310 identifies all locations from the parking locations repository 305 that are within a particular distance of the given location (and, optionally, that exclude locations within the restricted regions of any retailer locations).

The waiting direction module 250 includes a parking quality model 315 that produces a score for a given candidate parking location, the score quantifying how favorable that parking location is, e.g., from the perspective of balancing proximity to the retailer location against preserving parking availability and avoiding traffic congestion. The parking quality model 315 takes a number of features about a candidate parking location as input when producing a score for that location; these features represent variables that can influence the favorability of the location for parking. In some embodiments, the features include: a description of the candidate parking location (e.g., geographic coordinates); day/time of the parking for the order; an identifier of the retailer location associated with the order; a current degree of demand for pickers at the retailer location; a current average picker wait time at the retailer location before receiving an order; a current parking capacity of the parking location (e.g., 30%); a degree of current or anticipated traffic at the candidate parking location; safety parameters (e.g., average or current traffic, average degree of crime); and/or distance or travel time from the parking location to the retail location.

In some embodiments, the machine-learning training module 230 trains the parking quality model 315 using supervised reinforcement logistic regression on the input feature values. In some embodiments, the “ground truth” label corresponding to the input feature values for a single parking instance is a parking quality score that can be determined by feedback expressly provided by the pickers or other individuals who used the parking location (e.g., by an application of the online concierge system that runs locally on the picker client device 110 and queries the individual about the parking quality, such as “Please rate your parking location (scale of worst=1 to best=5)”.). Alternatively and/or additionally, in some embodiments the online concierge system 140 infers the parking quality score can be based on factors derived from data about the delivery, such as an amount of time (e.g., between parking and entering the store, between exiting the store and driving away, between parking and driving away, or the like). More recent quality scores can be weighted more heavily in order to take into account current conditions (e.g., that new construction has recently decreased the quality of a particular parking location).

The waiting direction module 250 includes a location suggestion module 320 that provides suggested parking locations to pickers, determining a location at which the picker is currently located (e.g., by obtaining GPS coordinates from the picker client device 110) and formulating suggested locations for that location. In some embodiments, the location suggestion module 320 first determines whether the picker's current location is within a restricted region defined for the intended retail location, and if not, does not provide any location suggestions, since the current location is acceptable; if the picker's location is currently within a restricted region for the retail location, however, then the location suggestion module 320 proceeds to identify suggested alternate parking locations. The location suggestion module 320 uses the candidate identification module 310 to identify candidate parking locations, e.g., for the picker's current location, and uses the parking quality model 315 to score some or all of those identified candidates by determining and providing the relevant input features to the parking model. The location suggestion module 320 may rank the candidate parking locations according to their scores.

In other embodiments, a two-part application of models is employed by the location suggestion module 320. A machine-learned parking prohibition model (not illustrated in FIG. 3) is first used to predict whether the current picker location is acceptable for use when parking at the retail location, or whether (in contrast) parking at that location is restricted. In such embodiments, the acceptability of parking is not merely determined by whether the picker is within a restricted region, but rather is determined based on many features that are input to the parking prohibition model, such as the current picker location, the current day/time, the current occupancy percentage of the parking area that encloses the current picker location, the current average volume of traffic within a given distance of the current picker location, the type of store corresponding to the current location and its historical order information (e.g., whether that store typically sells large and bulky items that are comparatively difficult to transport), the size (e.g., number of items) in the current order, historical information about the current shopper (e.g., shopper speed), and the like. If the parking prohibition model indicates that parking at the picker's current location is acceptable for parking, then the location suggestion module 320 need not make parking location suggestions; if, in contrast, the current location is not acceptable, the location suggestion module applies the parking model to the candidate parking locations, as described above.

The waiting direction module 250 includes a direction communication module 330 that communicates the location(s) suggested by the location suggestion module 320 to the picker client device 110 of the picker. For example, the direction communication module 330 may cause some or all of the suggested locations to be displayed on an electronic map within a browser or other application of the picker client device 110, and further may display navigation directions to a suggested location in response to the picker selecting that location using the user interface. The waiting direction module 250 may also display a notification that parking at the picker's current location is disfavored, and that the suggested alternatives are encouraged (e.g., “Parking at this retailer is restricted. Please select one of the displayed alternatives”).

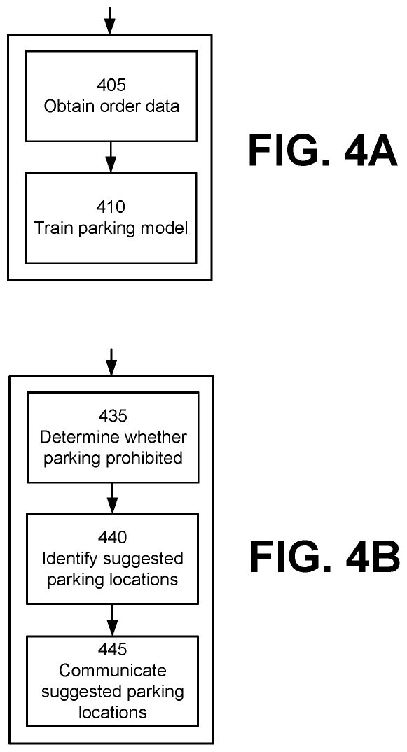

FIG. 4A is a flowchart of steps for producing the parking quality model 315, in embodiments in which the waiting direction module 250 itself produces the parking model (rather than obtaining it from a separate system). The waiting direction module 250 obtains 405 data about prior orders, e.g., made through the order management module 220. The machine-learning training module 230 trains the parking quality model 315 based on the obtained data as discussed above (e.g., by identifying orders taken outside restricted regions, determining the input features of interest, and performing logistic regression on those features to generate the model). The machine-learning training module 230 may re-train the parking quality model 315 (e.g., on a periodic schedule, such as daily) to take into account new received data (e.g., new feedback from shoppers on parking quality).

FIG. 4B is a flowchart of steps for suggesting parking locations to a picker, according to some embodiments. The waiting direction module 250 determines 435 whether parking is prohibited at a current location of the picker (as determined by picker client device 110). As described above with respect to the location suggestion module 320, this can involve determining whether the picker is within a restricted region near a retail location, or (more generally) whether a parking prohibition model indicates that parking is prohibited, given the relevant features for the current context (e.g., location, parking level, etc.). If parking at the current location is indeed prohibited (or likely prohibited, based on a model score output being above some threshold score), the waiting direction module 250 identifies 440 suggested alternative parking locations, such as identifying candidate locations using the candidate identification module 310 and scoring those candidates using the parking quality model 315 based on the features corresponding to the current context. The waiting direction module 250 communicates 445 the identified suggested parking locations to the picker, e.g., as discussed above with respect to the direction communication module 330 (such as indicating the locations on a graphical electronic map displayed on the picker client device 110).

The techniques described above for suggesting alternative parking locations take into account both the picker's time to a retail location and parking/traffic congestion concerns. This not only continues to provide pickers with efficient item pickup options, but also eases the community burdens of overparking and traffic congestion through its use of machine-learned predictions of which parking locations will be effective and non-burdensome under the current circumstances.

Although the steps of FIGS. 4A and 4B, as well as the functionality described in FIG. 3, are described as being performed by the online concierge system, in some embodiments some or all of the functionality can be performed on other systems, such as the picker client device 110. For example, the picker client device 110 may have an application (e.g., one authored by the entity also responsible for the online concierge system 140) that performs certain of these steps itself, with the relevant modules (such as the parking quality model 315, the location suggestion module 320, or the like) being part of or accessible to the application.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method performed at a computer system comprising a processor and a computer-readable medium, the method for identifying shopping parking locations that reduce congestion and comprising:
determining a geographic location of a client device of a shopper;
determining, using a machine-learned parking prohibition model, that parking for a first retail location is restricted; and
responsive to determining that the parking is restricted:
identifying a plurality of candidate parking locations for the first retail location;
scoring the plurality of candidate parking locations using a machine-learned parking quality model; and
providing suggestions of parking locations to the shopper based on the scoring.

2. The method of claim 1, wherein using the machine-learned parking prohibition model comprises determining features comprising at least one of: a current time, current occupancy of a parking area comprising the geographic location, or current volume of traffic for the geographic location.

3. The method of claim 1, further comprising generating a repository of parking locations, the generating comprising:
identifying locations of client devices of shoppers at prior times when the shoppers were assigned to orders; and
excluding, from the identified locations, locations within restricted areas of retail locations.

4. The method of claim 1, further comprising training the machine-learned parking quality model using logistic regression applied to features derived from data about prior orders.

5. The method of claim 1, further comprising:
receiving feedback from the shopper about one of the suggested parking locations at which the shopper parked; and
retraining the machine-learned parking quality model using the feedback from the shopper.

6. The method of claim 1, wherein scoring the plurality of candidate parking locations comprises providing, for the machine-learned parking quality model, input features comprising at least one of: a description of a candidate parking location; a current time; an identifier of the first retail location; a current degree of demand for shoppers at the first retail location; a current average shopper wait time at the first retail location before receiving an order; a current parking capacity of a candidate parking location; or safety parameters associated with the candidate parking locations.

7. The method of claim 1, wherein determining that parking for the first retail location is restricted comprises determining that the geographic location is within a proximate region with respect to the first retail location.

8. The method of claim 1, wherein providing the suggestions of the parking locations to the shopper based on the scoring comprises causing display of one or more of highest-scored ones of the candidate parking locations on an electronic map.

9. The method of claim 8, further comprising;
receiving a selection of one of the displayed candidate parking locations; and
providing navigation instructions from the geographic location to the selected candidate parking location.

10. A non-transitory computer-readable storage medium containing instructions that when executed by one or more processors perform actions comprising:
determining a geographic location of a client device of a shopper;
determining, using a machine-learned parking prohibition model, that parking for a first retail location is restricted; and
responsive to determining that the parking is restricted:
identifying a plurality of candidate parking locations for the first retail location;
scoring the plurality of candidate parking locations using a machine-learned parking quality model; and
providing suggestions of parking locations to the shopper based on the scoring.

11. The non-transitory computer-readable storage medium of claim 10, wherein using the machine-learned parking prohibition model comprises determining features comprising at least one of: a current time, current occupancy of a parking area comprising the geographic location, or current volume of traffic for the geographic location.

12. The non-transitory computer-readable storage medium of claim 10, the actions further comprising generating a repository of parking locations, the generating comprising:
identifying locations of client devices of shoppers at prior times when the shoppers were assigned to orders; and
excluding, from the identified locations, locations within restricted areas of retail locations.

13. The non-transitory computer-readable storage medium of claim 10, the actions further comprising training the machine-learned parking quality model using logistic regression applied to features derived from data about prior orders.

14. The non-transitory computer-readable storage medium of claim 10, the actions further comprising:
receiving feedback from the shopper about one of the suggested parking locations at which the shopper parked; and
retraining the machine-learned parking quality model using the feedback from the shopper.

15. The non-transitory computer-readable storage medium of claim 10, wherein scoring the plurality of candidate parking locations comprises providing, for the machine-learned parking quality model, input features comprising at least one of: a description of a candidate parking location; a current time; an identifier of the first retail location; a current degree of demand for shoppers at the first retail location; a current average shopper wait time at the first retail location before receiving an order; a current parking capacity of a candidate parking location; or safety parameters associated with the candidate parking locations.

16. The non-transitory computer-readable storage medium of claim 10, wherein determining that parking for the first retail location is restricted comprises determining that the geographic location is within a proximate region with respect to the first retail location.

17. The non-transitory computer-readable storage medium of claim 10, wherein providing the suggestions of the parking locations to the shopper based on the scoring comprises causing display of one or more of highest-scored ones of the candidate parking locations on an electronic map.

18. The non-transitory computer-readable storage medium of claim 17, the actions further comprising;
receiving a selection of one of the displayed candidate parking locations; and
providing navigation instructions from the geographic location to the selected candidate parking location.

19. A computer system comprising:
one or more computer processors; and
a computer-readable storage medium storing instructions that when executed by the one or more computer processors perform actions comprising:
determining a geographic location of a client device of a shopper;
determining, using a machine-learned parking prohibition model, that parking for a first retail location is restricted; and
responsive to determining that the parking is restricted:
identifying a plurality of candidate parking locations for the first retail location;
scoring the plurality of candidate parking locations using a machine-learned parking quality model; and
providing suggestions of parking locations to the shopper based on the scoring.

20. The computer system of claim 19, wherein using the machine-learned parking prohibition model comprises determining features comprising at least one of: a current time, current occupancy of a parking area comprising the geographic location, or current volume of traffic for the geographic location.
